(19) United States
(12) Patent Application Publication
(10) Pub. No.: US 2010/0055390 A1
(43) Pub. Date: Mar. 4, 2010

(54) MICROPHASE-SEPARATED STRUCTURE ON FLEXIBLE SUBSTRATE, AND METHOD OF MANUFACTURE THEREOF

(75) Inventors: KENICHI ISHIZUKA, KANAGAWA (JP); TAISEI NISHIMI, KANAGAWA (JP)

Correspondence Address: YOUNG & THOMPSON, 209 Madison Street, Suite 500, Alexandria, VA, 22314, US

(73) Assignee: FUJIFILM CORPORATION, TOKYO (JP)

(21) Appl. No.: 12/552,481

(22) Filed: Sep. 2, 2009

(30) Foreign Application Priority Data
Sep. 2, 2008 (JP) 2008-224635

(51) Int. Cl. B32B 7/00

(52) U.S. Cl. 428/119

(57) ABSTRACT

A structure includes a flexible substrate and, in order thereon, a metal layer, a metal adsorbing compound layer, and a block copolymer layer which has a microphase-separated morphology and is formed of a block copolymer obtained by bonding two or more mutually incompatible polymer chains. The microphase-separated morphology has one phase which is lamellar or cylindrical, and is oriented perpendicularly to the substrate.

### CROSS REFERENCE TO RELATED APPLICATIONS

This application claims priority to Japanese Patent Application No. 2008-224635, filed Sep. 2, 2008, the contents of which are incorporated herein by reference in their entirety. In addition, the entire contents of all patents and references cited in this specification are also incorporated herein by reference.

### BACKGROUND OF THE INVENTION

The present invention relates to a structure having a metal layer, a metal adsorbing compound layer, and a block copolymer layer in this order on a flexible substrate. The invention relates also to a method of manufacturing such a structure.

Recently, in the fields of optical materials and electronic materials, there has been a growing demand for greater integration, higher information density, and image information of higher definition. This has led to a need to form a fine, nanometer-scale structure (micropatterning, micropattern structure) in the materials used in these fields. In particular, to confer flexibility, handleability and lightweight properties for bendability during use and for lamination onto curved surfaces, there is an acute desire for the high-precision, low-cost manufacture of micropattern structures on flexible substrates such as polymer films.

Micropatterning processes that have been proposed include bottom-up techniques in which a microstructure is manufactured by employing “self-assembly”—i.e., the spontaneous formation of an ordered pattern. Of such techniques, block copolymers formed by bonding two or more different types of polymer chains are known to undergo phase separation at a deca-nanometer level by self-assembly to form a “microphase-separated morphology.” It is believed that, were it possible to orient the cylindrical or lamellar microdomains of such a microphase-separated morphology perpendicular to a flexible substrate, the resulting structures could be adapted for use as, e.g., phase shift films, polarizing films, components for electronic displays, and magnetic recording media, and employed in thus way in a broad range of fields, including energy, the environment and the life sciences.

In general, block copolymer structures (e.g., films) have a microphase-separated morphology with a regular orientation only in narrow regions (such regions are called “grains”) of the structure, and possess overall a microphase-separated morphology of irregular orientation composed of a plurality of aggregated grains. A number of efforts are currently being made to manufacture ordered patterns arrayed in specific directions on flexible substrates. For example, M. Kunz et al. (“Improved technique for cross-sectional imaging of thin polymer films by transmission electron microscopy,” Polymer 34, 2427-2430 (1993)) have vapor-deposited gold onto a polymer substrate, and created thereon a block copolymer film having a lamellar phase-separated morphology. T. Thurn-Albrecht et al. (“Nanoscopic templates from oriented block copolymer films,” Adv. Mater. 12, 787-791 (2000)) have vapor-deposited gold onto a polymer substrate, coated a block copolymer thereon and, by applying an electrical field while heating, have obtained a phase-separated morphology in which cylindrical microdomains are perpendicularly oriented. In addition, JP 3979470 B discloses the creation of a perpendicular cylindrical phase-separated morphology by coating a PET substrate with a block copolymer having a liquid-crystal mesogen on side chains.

### SUMMARY OF THE INVENTION

However, in the lamellar phase-separated morphology obtained by M. Kunz et al., the lamellar microdomains are oriented horizontally with respect to the substrate; a microphase-separated morphology oriented in the perpendicular direction is not obtained. Also, even though Thurn-Albrecht et al. are able to obtain a cylindrical microphase-separated morphology oriented perpendicularly with respect to a polymer substrate, achieving this effect requires the application of an electrical field. In a process where such an electrical field is applied, the number of operations (e.g., forming electrodes, applying voltage) increases, creating a need for a larger apparatus. Moreover, such a process is difficult to carry out over a large surface area and is thus undesirable in terms of productivity. Finally, in JP 3979470 B, because the block copolymer used is required to have a special structure, this approach lacks general versatility and applicability to other polymers is limited. Because sufficient study has yet to be done on controlling the orientation of the microphase-separated morphology, it has been difficult to manufacture, at low cost and over a large surface area, microphase-separated morphologies in which the microdomains are oriented perpendicularly on a flexible substrate such as a polymer substrate.

It is therefore an object of the present invention to provide a structure having a block copolymer layer with a microphase-separated morphology in which a cylindrical or lamellar phase is oriented perpendicularly to a flexible substrate such as a polymer substrate. Another object of the invention is to provide a method capable of manufacturing such a structure at low cost and over a large surface area.

The inventors have discovered that, by inserting a layer having specific qualities between a flexible substrate such as a polymer substrate and a block copolymer layer, a block copolymer layer having an oriented structure that is ordered can be obtained more easily than by conventional methods.

That is, the inventors have found that the above objects of the invention are achieved by the following structures, porous body and method.
(1) A structure including a flexible substrate and, in order thereon, a metal layer, a metal adsorbing compound layer, and a block copolymer layer which has a microphase-separated morphology and is formed of a block copolymer obtained by bonding two or more mutually incompatible polymer chains, wherein the microphase-separated morphology has one phase which is lamellar or cylindrical, and is oriented perpendicularly to the substrate.
(2) The structure of (1) above, wherein the metal adsorbing compound layer has a thickness which is equal to or larger than a surface roughness Ra of the metal layer.
(3) The structure of (1) or (2) above, wherein the metal adsorbing compound layer is a layer formed of a compound represented by general formula (1):

X-L-R General formula (1)

wherein R is a hydrogen atom, an optionally branched alkyl group or an alkoxy group, L is a divalent linkage group or merely a bond, X is a thiol group, an amino group, a selenol group, a nitrogen-containing heterocyclic group, an asymmetric or symmetric disulfide group, a sulfide group, a diselenide group or a selenide group.
(4) The structure of any one of (1) to (3) above, wherein the metal layer is a layer made of at least one metal selected from the group consisting of gold, platinum, silver, copper and iron.
(5) A porous body obtained by removing polymer chains in one phase of the microphase-separated morphology from the structure of any one of (1) to (4) above.
(6) A method of manufacturing the structure of any one of (1) to (4) above, including the steps of: forming a metal layer on a flexible substrate; forming a metal adsorbing compound layer on the metal layer; and forming a block copolymer layer on the metal adsorbing compound layer.

Accordingly, the present invention provides a structure having a block copolymer layer with a microphase-separated morphology in which a cylindrical or lamellar phase is oriented perpendicularly to a flexible substrate such as a polymer substrate. The invention also provides a method which is capable of manufacturing such a structure at a low cost and over a large surface area.

A porous body having nanosize pores can be obtained by removing the cylindrical phase in the microphase-separated morphology.

### BRIEF DESCRIPTION OF THE DRAWINGS

FIG. 1A is a perspective, cross-sectional view showing a structure having a cylindrical microphase-separated morphology according to one embodiment of the invention, and FIG. 1B is a top view of the same;

FIG. 2A is a perspective, cross-sectional view showing a structure having a lamellar microphase-separated morphology according to another embodiment of the invention, and FIG. 2B is a top view of the same;

FIG. 3 is an atomic force microscopic image taken from the top side of a specimen A;

FIG. 4 is a transmission electron microscopic image of a ultrathin section of the specimen A;

FIG. 5 is an atomic force microscopic image taken from the top side of a specimen B;

FIG. 6 is an atomic force microscopic image taken from the top side of a specimen C;

FIG. 7 is an atomic force microscopic image taken from the top side of a specimen D; and

FIG. 8 is an atomic force microscopic image taken from the top side of a specimen E.

### DETAILED DESCRIPTION OF THE INVENTION

The structure of the invention is described below in detail based on preferred embodiments shown in the accompanying drawings.

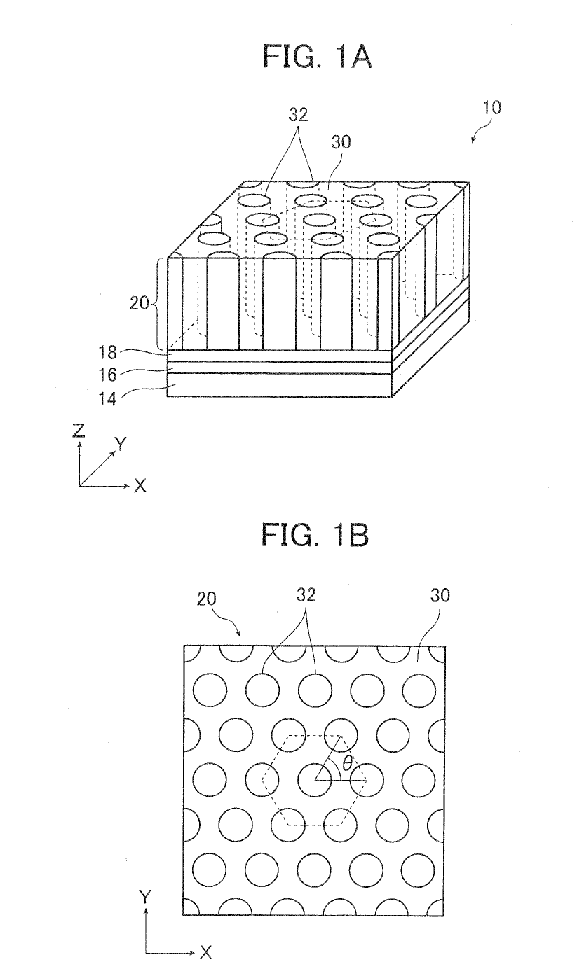

FIG. 1A is a perspective, cross-sectional view showing a structure (also referred to herein as a “structural body”) according to one embodiment of the invention.

A structure 10 shown in FIG. 1A has a layered structure in which a metal layer 16, a metal adsorbing compound layer 18, and a block copolymer layer 20 are deposited on a flexible substrate 14 in this order. In FIG. 1A, the block copolymer layer 20 has a microphase-separated morphology obtained by using a diblock copolymer (in which polymer A and polymer B are bonded together at the ends). Specifically, the block copolymer layer 20 forms a cylindrical microphase-separated morphology composed of a continuous phase 30 and cylindrical microdomains 32 distributed within the continuous phase 30, and the cylindrical microdomains 32 are oriented perpendicularly with respect to the flexible substrate 14.

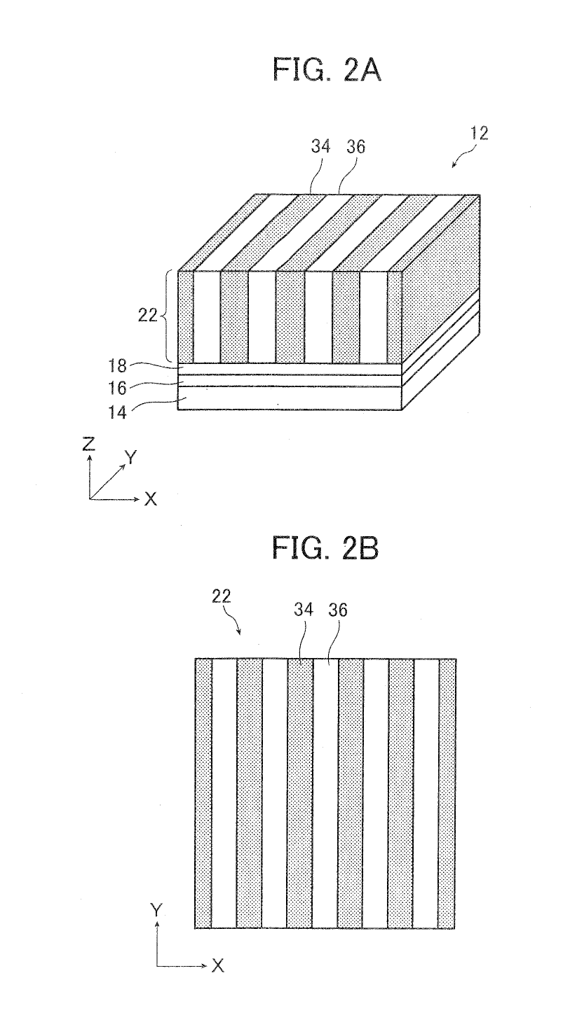

FIG. 2A is a perspective, cross-sectional view showing a structure according to another embodiment of the invention.

A structure 12 shown in FIG. 2A has a layered structure in which a metal layer 16, a metal adsorbing compound layer 18, and a block copolymer layer 22 are deposited on a flexible substrate 14 in this order. In FIG. 2A, the block copolymer layer 22 has a microphase-separated morphology obtained by using a diblock copolymer (in which polymer A and polymer B are bonded together at the ends). Specifically, the block copolymer layer 22 forms a lamellar microphase-separated morphology composed of lamellar phases 34 and 36, which are oriented perpendicularly with respect to the flexible substrate 14.

The flexible substrate 14, metal layer 16, and metal adsorbing compound layer 18 in the structure 10 shown in FIGS. 1A and 1B are the same components as those in the structure 12 shown in FIGS. 2A and 2B. FIGS. 1A, 1B, 2A and 2B do not limit the thicknesses of the flexible substrate 14, metal layer 16, metal adsorbing compound layer 18 and block copolymer layers 20 and 22.

Each of the flexible substrate 14, metal layer 16, metal adsorbing compound layer 18 and block copolymer layers 20, 22 making up the structure of the present invention is first described.

Flexible Substrate

The flexible substrate 14 of the present invention supports the metal layer 16, metal adsorbing compound layer 18 and block copolymer layer 20 or 22 deposited thereon and is not particularly limited as long as it is flexible. Illustrative examples include polymer substrates of polyimide (PI), polyethersulfone (PES), polymethyl methacrylate (PMMA), polycarbonate (PC), cycloolefin polymer (COP), polyethylene naphthalate (PEN), polyethylene terephthalate (PET), polypropylene (PP), liquid-crystal polymer (LCP), polydimethylsiloxane (PDMS) and triacetyl cellulose (TAC); and metal films such as copper foil and aluminum foil. Of these, polymer substrates are preferred on account of their easy processability and good handleability. Polyimide films, polyethylene naphthalate films and polyethylene terephthalate films are especially preferred because of their high heat resistance, excellent solvent resistance and good mechanical strength.

The flexible substrate 14 may optionally be subjected to, for example, a known corona discharge treatment in order to strengthen their adhesion to the subsequently described metal layer 16.

Metal Layer

The metal layer 16 of the present invention is a layer made of a metal which is formed on the upper side of the flexible substrate 14 to impart electrical conductivity to the structure (multilayer body). The metal layer 16 is preferably a layer made of at least one metal selected from the group consisting of gold, platinum, silver, copper, iron, silicon, aluminum, indium, titanium, zinc, zirconium, tin, magnesium, nickel, germanium, and gallium. Of these, copper, silver, gold, platinum and iron are preferably used in terms of low resistivity. The metal layer 16 may be made of a single metal or a combination of two or more metals.

The metal layer 16 in the present invention may be a monolayer formed by one of the above-mentioned materials, a monolayer made of two or more of the above materials, or a nmultilayer formed by stacking a plurality of such monolayers.

The metal layer 16 preferably has a thickness of 10 to 500 nm and more preferably 10 to 200 nm although the layer thickness may be set as appropriate for the intended purpose of the structure. If the metal layer is too thin, the surface of the flexible substrate 14 cannot be covered completely and uniformly. On the other hand, if the metal layer is too thick, cracking or delamination will occur between the substrate and the metal layer 16. Neither situation is desirable.

It is preferable for the metal layer 16 to be as smooth as possible (to have a surface roughness of 0) in terms of capability to form the metal adsorbing compound layer 18 to be described below more uniformly. The surface roughness is typically 5 nm or less, and preferably 2 nm or less. As used herein, “roughness” refers to the roughness Ra (mean surface roughness) value determined by conducting a roughness analysis on atomic force microscope topographic images measured with a conventional, commercially available atomic force microscope (also abbreviated below as “AFM”).

Metal Adsorbing Compound Layer

The metal adsorbing compound layer 18 of the present invention is formed on the metal layer 16 to control the orientation of the microphase-separated morphology of the block copolymer layer 20 or 22 to be described later. The metal adsorbing compound layer 18 is a layer formed of a compound having at least one metal adsorbing group. The “metal adsorbing group” refers to a group which is adsorbable on a metal and illustrative examples thereof include thiol group, sulfide group, disulfide group, amino group, phosphonate group, phosphino group, cyano group, isocyano group, carboxy group, selenol group, nitrogen-containing heterocyclic group, alkene group, trivalent phosphate compound-derived group, selenide group, diselenide group, isonitrile group, nitro group, isothiocyanate group, xanthate group, thiocarbamate group, thionic acid group and dithionic acid group. Of these, a compound having at least one metal adsorbing group selected from the group consisting of thiol group, sulfide group, disulfide group, amino group, phosphino group and selenol group is preferably used.

A so-called self-assembled monolayer (hereinafter also abbreviated as “SAM”) is preferably used as the layer formed of a compound having such a metal adsorbing group. SAM is a monomolecular layer in which material molecules assemble together at the surface of a target (interface between a solid and a liquid or interface between a solid and a gas) and autonomically build up to take a structure where the material molecules are regularly arrayed. The compound having a metal adsorbing group in the present invention has a structure in which the metal adsorbing group adsorbs on and binds to the metal layer 16 whereas the other molecular chain moieties extend outward from the metal layer 16.

A preferred example of the metal adsorbing group-containing compound includes a compound represented by general formula (1):

X-L-R General formula (1)

wherein R is a hydrogen atom, an optionally branched alkyl group or an alkoxy group, L is a divalent linkage group or merely a bond, X is a thiol group, an amino group, a selenol group, a nitrogen-containing heterocyclic group, an asymmetric or symmetric disulfide group, a sulfide group, a diselenide group or a selenide group.

In general formula (1), R is a hydrogen atom, an optionally branched alkyl group or an alkoxy group. The alkyl group is not subject to any particular limitation and preferably contains 1 to 20 carbon atoms and more preferably 1 to 18 carbon atoms. Illustrative examples thereof include methyl group, ethyl group, propyl group and isopropyl group. The alkoxy group is not subject to any particular limitation and preferably contains 1 to 3 carbon atoms. Illustrative examples thereof include methoxy group, ethoxy group and propoxy group.

In general formula (1), L is a divalent linkage group or merely a bond. Illustrative examples include alkylene groups (of preferably 1 to 20 carbon atoms and more preferably 1 to 18 carbon atoms which may be linear, cyclic or branched), —O—, —S—, arylene groups, —CO—, —NH—, —SO₂—, —COO—, —CONH— and groups that are combinations thereof. Of these, alkylene groups, arylene groups or combinations thereof are preferably used. In cases where L represents merely a bond, the R moiety in general formula (1) is directly linked to X.

In general formula (1), X is a thiol group (—SH), an amino group (—NH₂), a nitrogen-containing heterocyclic group, a selenol group (—SeH), an asymmetric or symmetric disulfide group (—SS-L′-R′), a sulfide group (—S-L′-R′), a diselenide group (—SeSe-L′-R′) or a selenide group (—Se-L′-R′).

L′ and R′ in the disulfide group, sulfide group, diselenide group and selenide group are defined in the same manner as L and R in general formula (1). L′ and L may be the same or different, and R′ and R may also be the same or different.

Illustrative examples of the metal adsorbing group-containing compound include hexanethiol, octanethiol, dodecanethiol, hexadecanethiol, octadecanethiol, hexylamine, octylamine, dodecylamine, hexadecylamine, methoxyphenylethylamine, dihexyl disulfide, dioctyl disulfide, didodecyl disulfide, diisoamyl disulfide, didecyl sulfide, hexaneselenol, hexadecaneselenol, and dimethyl diselenide.

In the present invention, the metal adsorbing compound layer 18 might contribute to control of the orientation of the block copolymer layer 20 deposited thereon and serve to alleviate the effects of the surface roughness of the metal layer 16. The thickness of the metal adsorbing compound layer 18 is preferably equal to or larger than the surface roughness Ra of the metal layer 16. The thickness of the metal adsorbing compound layer 18 can be increased by using a compound having a metal adsorbing group with a longer molecular chain length, and decreased by using a compound having a metal adsorbing group with a shorter molecular chain length. The layer thickness can be measured by a technique such as cross-sectional transmission electron microscopic analysis. A simple method that may be used for estimating the layer thickness is molecular computation with a program such as MOPAC (e.g., WinMOPAC (Ver. 3.9.0)).

The metal adsorbing compound layer 18 preferably has a thickness which is equal to or larger than the surface roughness Ra of the metal layer 16 as described above. More specifically, the thickness of the metal adsorbing compound layer 18 is preferably at least 0.5 nm, more preferably at least 1 nm and even more preferably 1.5 nm to 10 nm. Within the above range, a cylindrical or lamellar microphase-separated morphology having a more ordered array can be obtained in the block copolymer layer 20 or 22.

The contact angle of the metal adsorbing compound layer 18 with water can be controlled by means of, for example, the metal adsorbing group-containing compound used. An optimal value is suitably selected based on the type of block copolymer described subsequently. To obtain a micropattern having a greater degree of order, the contact angle is preferably from 50 to 120°, and more preferably from 55 to 115°. “Contact angle” refers herein to the static contact angle, which is measured by the sessile drop method at 22° C. using a contact goniometer. As used herein, “static contact angle” refers to the contact angle under conditions where flow and other changes in state associated with time do not arise.

In terms of obtaining a micropattern having a greater degree of order, it is desirable for the respective components of the block copolymer to have surface tensions with the metal adsorbing compound layer 18 which differ therebetween by preferably from 0 to 6 mN/m and more preferably from 0 to 1 mN/m. The difference between the surface tensions of the respective components of the block copolymer is obtained as follows. The contact angles of each component and of the substrate used, with three types of liquids—tetradecane, methylene iodide and water—are measured, and the surface free energies are derived. Next, the surface tension of each component with the substrate is computed, then the difference between these surface tensions can be computed.

Block Copolymer Layer

The block copolymer layer 20 or 22 of the present invention is formed on the metal adsorbing compound layer 18 and has a microphase-separated morphology in which a cylindrical or lamellar phase which is hereinafter also referred to as “microdomains” is oriented substantially perpendicularly to the flexible substrate 14. Owing to the structural anisotropy of the block copolymer layers 20 and 22, optical anisotropy, anisotropic electrical conductivity, anisotropic heat conductivity, and anisotropic ionic conductivity are imparted to the structure.

Block Copolymer

The term ‘block copolymer’ generally refers to a copolymer in which a plurality of types of homopolymer chain are bonded to each other as blocks (components). For example, there are polymers in which a polymer A chain composed of monomer A repeating units and a polymer B chain composed of monomer B repeating units are bonded together at their respective ends. Block copolymers are known to differ from random copolymers in that, for example, they form a structure wherein a phase A of aggregated polymer A chains and a phase B of aggregated polymer B chains are spatially separated (microphase-separated morphology). In the phase separation (macrophase separation) obtained with ordinary polymer blends, because two types of polymer chains can be completely separated, complete separation into two phases is ultimately achieved, resulting in a unit cell size of at least 1 μm. By contrast, the unit cells in microphase-separated morphologies that can be obtained with a block copolymer have a size on the order of from several nanometers to several deca-nanometers. Moreover, depending on the composition of the blocks therein, the microphase-separated morphologies are known to exhibit a variety of configurations, such as spherical micellar, cylindrical or lamellar morphologies.

The block copolymer used in the present invention is composed of two or more types of polymers that are mutually incompatible, and may be in the form of any one of the following: a diblock copolymer, a triblock copolymer or a multiblock copolymer. Specifically, referring to a portion composed of polymer A as an “A block” and a portion composed of polymer B as a “B block,” exemplary block copolymers include A-B type block copolymers having an -A-B- structure and composed of one A block bonded with one B block, A-B-A type block copolymers having an -A-B-A- structure and composed of A blocks bonded to both ends of a B block, and B-A-B type block copolymers having a -B-A-B- structure and composed of B blocks bonded to both ends of an A block. In addition, use may also be made of block copolymers which have a -(A-B)ₙ- structure and are composed of a plurality of A blocks and B blocks. Of these, from the standpoint of availability and ease of synthesis, A-B type block copolymers (diblock copolymers) are preferred. The chemical bonds connecting the polymers to each other are preferably covalent bonds.

Illustrative examples of the polymers which make up the block copolymer used in the invention include vinyl polymers such as polystyrene, polymethylstyrene, polydimethylstyrene, polytrimethylstyrene, polyethylstyrene, polyisopropylstyrene, polychloromethylstyrene, polymethoxystyrene, polyacetoxystyrene, ,polychlorostyrene, polydichlorostyrene, polybromostyrene, polytrifluoromethylstyrene, polymethyl methacrylate, polyethyl methacrylate, polybutyl methacrylate, polyisobutyl methacrylate, polyhexyl methacrylate, poly(2-ethylhexyl methacrylate), polyisodecyl methacrylate, polylauryl methacrylate, polyphenyl methacrylate, polymethoxyethyl methacrylate, polymethyl acrylate, polyethyl acrylate, polybutyl acrylate, polyhexyl acrylate, poly(2-ethylhexyl acrylate), polyphenyl acrylate, polymethoxyethyl acrylate, polyglycidyl acrylate, polyvinyl acetate, polyvinyl propionate, polyvinyl butyrate, polyvinyl isobutyrate, polyvinyl caproate, polyvinyl chloroacetate, polyvinyl methoxyacetate, polyvinyl phenyl acetate, polyethylene, polypropylene, polyisobutylene, polyvinyl chloride, polyvinylidene chloride, polytetrafluoroethylene and polyvinylidene fluoride; diene polymers such as polybutadiene and polyisoprene; ether polymers such as polymethylene oxide, polyethylene oxide, polythioether, polydimethylsiloxane and polyethersulfone; ester-based condensation polymers such as poly(ε-caprolactone) and polylactic acid; and amide-based condensation polymers such as nylon 6, nylon 66, poly(m-phenylene isophthalamide), poly(p-phenylene terephthalamide) and polypyromellitimide. The combination of polymer chains making up the block copolymer is not subject to any particular limitation, provided the polymer chains used are mutually incompatible. For example, combinations of different vinyl copolymers, a vinyl polymer with a diene polymer, a vinyl polymer with an ether polymer, a vinyl polymer with an ester-based condensation polymer, or different diene polymers are preferred. The use of one or more vinyl polymers is more preferred. The use of a combination of different vinyl polymers is most preferred.

Specific examples include polystyrene/polymethyl methacrylate, polystyrene/polyethylene glycol, polyisoprene/poly(2-vinylpyridine), polymethyl acrylate/polystyrene, polybutadiene/polystyrene, polyisoprene/polystyrene, polystyrene/poly(2-vinylpyridine), polystyrene/poly(4-vinylpyridine), polystyrene/polydimethylsiloxane, polybutadiene/polyethylene oxide and polystyrene/polyacrylic acid. Of these, from the standpoint of availability and versatility, block copolymers such as polystyrene/polymethyl methacrylate, polystyrene/polyethylene glycol, polyisoprene/polystyrene, polystyrene/poly(2-vinylpyridine), polystyrene/poly(4-vinylpyridine) and polybutadiene/polyethylene oxide are preferred.

The block copolymer in the present invention is preferably one in which the mutually incompatible polymer block chains making up the block copolymer have a large difference in polarity. The polarity difference can be numerically expressed as, for example, the solubility parameter difference (SP difference). The solubility parameter can be estimated from the molecular structure. Numerous methods for calculating the theoretical solubility parameter have been proposed, including those of Small, Hoy and Fedors. Of these, Fedors theoretical solubility parameter does not require the polymer density parameter, and thus is an effective method of calculation also for polymers having a novel structure (Nippon Setchaku Kyokaishi 22, No. 10, 564-567 (1986)). In Fedors method of calculation, the theoretical solubility parameter (units: (cal/cm³)^{1/2}) can be determined by Formula 2 below using the bond energy and energy of molecular motion Δei possessed by the atoms or atomic groups such as polar radicals making up the polymer, the bond energy and energy of molecular motion ΣΔei of repeating units making up the polymer, the occupied volume Δvi of atoms or atomic groups such as polar radicals making up the polymer, and the occupied volume ΣΔvi of repeating units making up the polymer.

SP=(ΣΔei/ΣΔvi)^{1/2} Formula 2:

For example, the theoretical solubility parameter for polystyrene is estimated to be 14.09 (cal/cm³)^{1/2}, and the theoretical solubility parameter for polymethyl methacrylate is estimated to be 10.55 (cal/cm³)^{1/2}. Therefore, the polarity difference (SP difference) in a block copolymer composed of a polystyrene block chain and a polymethyl methacrylate block chain is 3.54 (cal/cm³)^{1/2}.

The weight-average molecular weight (Mw) of the block copolymer according to the present invention is suitably selected according to the intended use, and is preferably at least 1×10⁴, more preferably from 1×10⁴ to 1×10⁷, and even more preferably from 5×10⁴ to 1×10⁶. This weight-average molecular weight (Mw) is the polystyrene-equivalent weight-average molecular weight obtained following measurement by gel permeation chromatography (GPC).

The block copolymer of the present invention preferably has a narrow molecular weight distribution. Specifically, the molecular weight distribution (Mw/Mn) expressed in terms of the weight-average molecular weight (Mw) and the number-average molecular weight (Mn) is preferably from 1.00 to 1.50, and more preferably from 1.00 to 1.15. By having the Mw/Mn value fall within the above range, a microphase-separated morphology of more uniform size can be formed.

The copolymerization ratio of the block copolymer in the invention is suitably selected so as to enable a cylindrical or lamellar microphase-separated morphology to be obtained in the block copolymer layers 20 and 22.

For example, in the case of a cylindrical microphase-separated morphology composed of a diblock copolymer (A-B type) or a triblock copolymer (A-B-A type) as shown in FIG. 1A, the volumetric ratio between polymer A and polymer B which make up the copolymer (polymer A/polymer B) is preferably from 0.9/0.1 to 0.65/0.35 or from 0.35/0.65 to 0.1/0.9, and more preferably from 0.8/0.2 to 0.7/0.3 or from 0.3/0.7 to 0.2/0.8. Within the above range, a cylindrical microphase-separated morphology having a more highly ordered array can be obtained.

In the case of a similarly composed lamellar microphase-separated morphology as shown in FIG. 2A, the volumetric ratio between polymer A and polymer B which make up the copolymer (polymer A/polymer B) is preferably from 0.65/0.35 to 0.35/0.65, and more preferably from 0.6/0.4 to 0.4/0.6. Within the above range, a lamellar microphase-separated morphology having a more highly ordered array can be obtained.

The block copolymer of the present invention may be synthesized by a known method. Examples of methods that may be employed for this purpose include living anionic polymerization, living cationic polymerization, living radical polymerization, group transfer polymerization and ring-opening metathesis polymerization. More specific examples include living polymerization processes which use various types of monomers and carry out polymerization from the ends of the polymer chain (anionic polymerization, cationic polymerization, living radical polymerization), living polymerization processes in which synthesis takes place from the center of the polymer chain (anionic polymerization), and synthesis processes which involve bonding the ends of end-functional polymers (anionic polymerization, living radical polymerization). Commercially available products may also be used.

Microphase-Separated Morphology

The block copolymer layers 20, 22 have microphase-separated morphologies in which a cylindrical phase and a lamellar phase which are hereinafter also referred to as “microdomains” are oriented substantially perpendicularly to the substrate, respectively. As described above, FIG. 1A shows a perspective, cross-sectional view of a structure having a cylindrical microphase-separated morphology obtained using a diblock copolymer (in which polymer A and polymer B are bonded at the ends thereof). “Cylindrical microphase-separated morphology” refers herein to a structure in which one of the separated phases is cylindrical.

As shown in FIG. 1A, the block copolymer layer 20 has the microphase-separated morphology composed of the continuous phase 30 and the cylindrical microdomains 32 distributed within the continuous phase 30, and is situated on the surface of the flexible substrate 14. The continuous phase 30 and the cylindrical microdomains 32 are respectively formed of the polymer A and the polymer B which make up the block copolymer. The cylindrical microdomains 32 are distributed within the continuous phase 30 and oriented substantially perpendicularly to the flexible substrate 14, that is, in the Z-axis direction in FIG. 1A. As shown in FIG. 1B, the cylindrical microdomains 32 preferably have a zigzag arrangement in the horizontal plane of the applied film (the plane XY in FIG. 1B), and most preferably form an ordered array having a hexagonal lattice-like pattern. Here, “hexagonal lattice-like” denotes a structure in which the angle θ between one microdomain and two adjacent microdomains is substantially 60 degrees (where “substantially 60 degrees” means from 50 to 70 degrees, and preferably from 55 to 65 degrees). The ordered array of microdomains, although exemplified here by assuming a hexagonal lattice-like pattern, is not limited to this arrangement. For example, there are also cases in which the ordered array of microdomains assumes a square arrangement. Nor are the cylindrical microdomains 32 limited to being arranged in an ordered pattern; cases in which the cylindrical microdomains 32 are arranged in a non-ordered pattern are also encompassed by the invention.

The size (diameter) of the cylindrical microdomains 32 may be suitably controlled by, for example, the molecular weight of the block copolymer used, and is preferably from 5 to 200 nm, and more preferably from 10 to 100 nm. If the cylindrical microdomains 32 have a shape that is elliptical, the major axis of the ellipse should fall within the above range. The distance between mutually neighboring microdomains (distance between the center axes) may be suitably controlled by means of, for example, the molecular weight of the block copolymer used, and is preferably from 5 to 300 nm, and more preferably from 10 to 150 nm. The size of the microdomains and the distance between the microdomains can be measured by examination with an atomic force microscope or the like. The term ‘microdomain’ is commonly used to denote the domains in a multiblock copolymer, and is not intended here to specify the size of the domains.

The cylindrical microdomains 32 are oriented perpendicularly to the flexible substrate 14, and are preferably substantially perpendicular. The expression ‘substantially perpendicular’ here denotes that the center axes of the cylindrical microdomains 32 are inclined to the normal of the flexible substrate 14 at an angle of not more than ±45°, and preferably not more than ±30°. The angle of inclination can be measured by the TEM analysis of ultrathin sections, small-angle x-ray diffraction analysis or some other suitable technique.

As described above, FIG. 2A shows a perspective, cross-sectional view of a structure having a lamellar microphase-separated morphology obtained using a diblock copolymer (in which a polymer A and a polymer B are bonded at the ends thereof). “Lamellar microphase-separated morphology” refers herein to a structure in which both phases are lamellar (in the form of a plate). As shown in FIG. 2A, the lamellar phases are alternately disposed in the block copolymer layer 22. The lamellar phases 34 and 36 are formed of, respectively, the polymer A and the polymer B which make up the block copolymer. The lamellar phases are oriented perpendicularly to the flexible substrate 14, that is, in the Z-axis direction in FIG. 2A.

The width of the lamellar phases 34 and 36 may be suitably controlled by, for example, the molecular weight of the block copolymer used, and is preferably from 5 to 200 nm, and more preferably from 10 to 100 nm. The width of the lamellar phases can be measured by, for example, examination with an atomic force microscope.

The lamellar phases 34 and 36 are oriented perpendicularly to the flexible substrate 14, and are preferably substantially perpendicular. The expression ‘substantially perpendicular’ here means that the interfaces between the lamellar phases in the Z-axis direction in FIG. 2A are inclined to the normal of the flexible substrate 14 at an angle of not more than ±45°, and preferably not more than ±30°. The angle of inclination can be measured by the TEM analysis of ultrathin sections, small-angle x-ray diffraction analysis, or some other suitable technique.

The invention is not limited to cases in which the block copolymer layers 20 and 22 have an ordered pattern as a whole; cases in which the layers have, in part, a non-ordered pattern are also encompassed by the invention.

The average thickness of each of the block copolymer layers 20 and 22 may be suitably controlled by varying, for example, the concentration of the block copolymer used, although the thickness is preferably from 10 to 5000 nm, and more preferably from 50 to 2500 nm. Within this range, the orderliness of the resulting microphase-separated morphology is further enhanced. The layer thickness is obtained by taking measurements at three or more random points with a suitable known apparatus such as a profiler (KLA-Tencor Corp.), and calculating the arithmetical mean of the measurements.

The structures 10 and 12 of the invention are layered structural bodies (multilayer bodies) as described above, and the specific shapes thereof are not subject to any particular limitation; a suitable and optimal shape may be selected according to the intended purpose. A film-like shape having a thickness of from 0.05 to 500 μm is preferred.

In the layered structural body (multilayer body) of the invention, because the substrate is a flexible substrate, the structural body itself has ample flexibility, providing considerable potential for use in a broad range of fields and applications. Examples of possible applications include photomasks, anisotropic electrically conductive films, anisotropic ion-conductive films, photonic crystals, phase shift films, polarizing films, screens, color filters, components for electronic displays, photoelectric conversion elements, nanoimprint molds, magnetic recording media, acoustic vibration materials, sound-absorbing materials and vibration-damping materials. Use in photomasks, anisotropic electrically conductive films, anisotropic ion-conductive films, photonic crystals, phase shift films and polarizing films is especially promising.

In particular, the structure of the invention has the metal layer as a constituent layer and exhibits electrical conductivity, and therefore use in, for example, anisotropic electrically conductive films, anisotropic thermally conductive films, anisotropic ion-conductive films, low-dielectric-constant films, membranes for protein separation, and biosensors can be promising.

A porous body having nanosize pores can be obtained by removing the polymer chains within one of the phases in the lamellar or cylindrical microphase-separated morphology that forms within the block copolymer layer of the layered structural body. In particular, by dissolving only the cylindrical microdomain 32 portions shown in FIG. 1A, nanosize cylindrical throughholes can be created in the block copolymer layer.

Removal may be carried out using, without particular limitation, any suitable method known to the art. Illustrative examples of methods for decomposing and removing one of the phases (decomposition step) include ion beam etching, ozonolysis treatment, UV irradiation and deep-UV irradiation. Use is made of a method and conditions which are suitable and optimal for the polymer material to be decomposed. Of the above, UV irradiation and deep-UV irradiation are preferred. The source of the ultraviolet light may be, for example, a high-pressure mercury vapor lamp or an electrodeless lamp. The illuminance of the UV light, while not subject to any particular limitation, is preferably from 10 to 300 mW. The total dose of UV light is preferably from 1 to 50 J/cm². It is also possible to use other methods of decomposition and removal, such as thermal decomposition of the polymer material by heating the polymer material to be decomposed to or above its thermal decomposition temperature.

Following the above removal by decomposition, a washing step with a suitable solvent (e.g., acetic acid, methanol, water) may be carried out. The size of the pores obtained by the above method corresponds to the size of the above-described cylindrical microdomains or the lamellar phases.

The resulting porous body having nanosize pores can be applied to diverse applications. Examples of such applications include electronic information recording media, adsorbents, nanoscale reaction site membranes, separation membranes, and polarizing plate-protecting films in liquid-crystal displays and plasma displays.

Next, the method of manufacturing the structure of the invention is described. The inventive structure is manufactured primarily by the following three steps:
(Step 1) forming a metal layer on a flexible substrate;
(Step 2) forming a metal adsorbing compound layer on the metal layer obtained in Step 1;
(Step 3) forming a block copolymer layer on the metal adsorbing compound layer obtained in Step 2;

Each of these steps and the materials used therein are described in detail below.

Step 1

Step 1 is the step of forming the metal layer 16 on the flexible substrate 14. The method of forming the metal layer 16 on the foregoing flexible substrate 14 is not particularly limited and any known method may be used. Examples of the method that may be used include physical vapor deposition processes such as vacuum evaporation and sputtering, chemical vapor deposition processes, and plating. A vacuum evaporation or sputtering process is preferable on account of the ease of controlling such properties as the thickness and density of the layer obtained.

Step 2

Step 2 is the step of forming the metal adsorbing compound layer 18 on the metal layer 16 obtained in Step 1. The method of forming the metal adsorbing compound layer 18 on the metal layer 16 is not particularly limited and the method described in, for example, Chemical Review, vol. 105, pp. 1103-1169 (2005) may be used. Specific examples include methods in which the metal adsorbing compound is coated, either directly as is or after dissolution in a solvent, onto the metal layer; and methods in which the substrate on which the metal layer has been deposited is immersed in a solution containing the metal adsorbing compound. The reaction time and temperature are selected as appropriate for the method and the metal adsorbing compound which are used. Following treatment with the metal adsorbing compound, if necessary, rinsing with a solvent may be carried out.

The solvent used for preparing the solution containing the metal adsorbing compound should be one which dissolves the metal adsorbing compound, and is suitably selected. Illustrative examples thereof include toluene, chloroform, dichloromethane, ethanol, methanol, DMF, DMAc, DMSO, acetone, MEK, hexane, octane, THF, dioxane, and water. The concentration of the metal adsorbing compound in the solution is preferably from 0.10 to 5.0 wt %, and more preferably from 0.50 to 2.0 wt %. Within the above range, a more uniform metal adsorbing compound layer is readily obtained.

Step 3

Step 3 is the step of forming the block copolymer layer 20 or 22 on the metal adsorbing compound layer 18 obtained in Step 2. The method of forming the block copolymer layer 20 or 22 on the metal adsorbing compound layer 18 is not subject to any particular limitation. However, from the standpoint of the ease of controlling layer thickness, a method which involves coating the block copolymer-containing solution is preferred.

The coating method is not subject to any particular limitation. Common coating methods which may be used include spin coating, solvent casting, dip coating, roll coating, curtain coating, slide coating, extrusion coating, bar coating and gravure coating. From the standpoint of productivity and other considerations, spin coating is preferred. The spin coating conditions are suitably selected according to the block copolymer used. After coating, a drying step may be carried out if necessary. The drying conditions for solvent removal are suitably selected according to the substrate employed and the block copolymer used, although it is preferable to carry out such treatment at a temperature of from 20 to 200° C. for a period of from 0.5 to 336 hours. The drying temperature is more preferably from 20 to 180° C., and even more preferably from 20 to 160° C. Such drying treatment may be carried out in several divided stages. This drying treatment is most preferably carried out in a nitrogen atmosphere, in low-concentration oxygen or at an atmospheric pressure of 10 torr or less.

The solvent used to prepare the block copolymer-containing solution should be one that dissolves the block copolymer, and is selected as appropriate for both types of polymer used. Illustrative examples include toluene, chloroform, dichloromethane, dimethylformamide, dimethylacetamide, dimethylsulfoxide, tetrahydrofuran, 1,4-dioxane, acetone, diethylketone, methyl ethyl ketone, methyl isobutyl ketone, isopropanol, ethanol, methanol, hexane, octane, tetradecane, cyclohexane, cyclohexanone, acetic acid, ethyl acetate, methyl acetate, pyridine, N-methylpyrrolidone and water. Of these, toluene, chloroform, dichloromethane, dimethylformamide and methyl ethyl ketone are preferred. The concentration of the block copolymer in the solution is preferably from 0.10 to 20.0 wt %, and more preferably from 0.25 to 15.0 wt %. Within this range, the solution is easy to handle during coating and a uniform film can readily be obtained.

Following the completion of Step 3, if necessary, the structure (multilayer body) obtained in Step 3 may be subjected to heat treatment (heating step). The heating temperature and time are suitably set in accordance with the block copolymer used and the layer thickness, although heating is generally carried out at or above the glass transition temperature of the block copolymer. The heating temperature may typically be set in a range of from 60 to 300° C., although a temperature of from 80 to 270° C. is preferred based on the glass transition temperature of the monomer units making up the block copolymer. A heating time of at least one minute is suitable, although a heating time of from 10 to 1,440 minutes is preferred. To prevent oxidative degradation of the block copolymer film by heating, heating is preferably carried out in an inert atmosphere or a vacuum.

Following the completion of Step 3, if necessary, the structure (multilayer body) obtained in Step 3 may be treated by exposure within an organic solvent vapor atmosphere (solvent treatment step). The organic solvent employed for this purpose is suitably selected according to the block copolymer used. Preferred examples include benzene, toluene, xylene, acetone, methyl ethyl ketone, chloroform, methylene chloride, tetrahydrofuran, dioxane, hexane, octane, methanol, ethanol, acetic acid, ethyl acetate, diethyl ether, carbon disulfide, dimethylformamide and dimethylacetamide. Of these, toluene, xylene, acetone, methyl ethyl ketone, chloroform, tetrahydrofuran and dioxane are preferred. Toluene, methyl ethyl ketone, chloroform and dioxane are more preferred.

As described above, in the present invention, by providing a metal layer, a metal adsorbing compound layer and a block copolymer layer on a flexible substrate, there can be obtained, at high definition and low cost, a micropattern morphology on the flexible substrate such as a polymer substrate (film), and more particularly a microphase-separated morphology oriented perpendicularly to the substrate. Attempts have hitherto been made to create perpendicularly oriented cylindrical microphase-separated morphologies on a silicon wafer (see, for example, B. H. Sohn et al. Polymer 43, 2507-2512 (2002)). However, the microphase-separated morphologies obtained have not been sufficiently ordered. Moreover, production over large surface areas on substrates such as silicon wafers has been impossible and the substrate itself has been rigid, thus limiting applications and resulting in poor practical utility. By contrast, the present invention uses a flexible substrate such as a polymer substrate and obtains a structural body having a micropattern over a large surface area and at low cost, enabling the development of various applications able to make the most of such flexibility. Moreover, block copolymers composed of general-purpose polymers can be used, which is industrially highly beneficial. Although the mechanism for the orientation of the microphase-separated morphology of the block copolymer has yet to be sufficiently elucidated in the literature and the detailed mechanism of operation of the present invention is not well understood, it is presumed that the use of a metal layer and a metal adsorbing compound layer makes it possible to obtain substrate surface qualities (surface energy, surface roughness) suitable for perpendicular orientation.

### EXAMPLES

Examples of the invention are provided below by way of illustration and not by way of limitation.

Contact angle measurements in the following examples were carried out by depositing a 2μL drop of ion-exchanged water on the film and measuring the water drop contact angle on the film surface 10 seconds later with a contact angle goniometer (DropMaster 700, manufactured by Kyowa Interface Science Co., Ltd.). Atomic force microscope (AFM) observations were carried out with a SPA-400 system (Seiko Instruments, Inc.), on the basis of which values such as the subsequently described surface roughness were measured. Scanning transmission electron microscope (STEM) observations were carried out using an HD-2300 system (Hitachi High-Technologies Corporation).

### Example 1

Gold was vapor-deposited on a polyimide film (UPILEX-50S available from Ube Industries, Ltd.) to prepare a gold layer with a thickness of 50 nm. The gold layer had a surface roughness Ra of 0.91 nm. Following vapor deposition, the film was immersed in a 1 mM ethanol solution of hexadecanethiol and allowed to stand for 1 day. Subsequently, the resulting film was rinsed with ethanol and dried to prepare a flexible metal substrate 1 on which a metal adsorbing compound layer was deposited. In this case, the metal adsorbing compound layer was a monomolecular layer. Assuming the thickness of this layer to be about the chain length of one molecule of the metal adsorbing compound, from calculations with WinMOPAC (Ver. 3.9.0), the thickness of the metal adsorbing compound layer was estimated to be about 2.3 nm. Following vapor deposition, the contact angle with water was 20.0°. Following surface modification, the contact angle with water was 105.4±7°. The difference between the surface tension of polystyrene (PS) with the substrate and the surface tension of polymethyl methacrylate (PMMA) with the substrate was 0.26 mN/m.

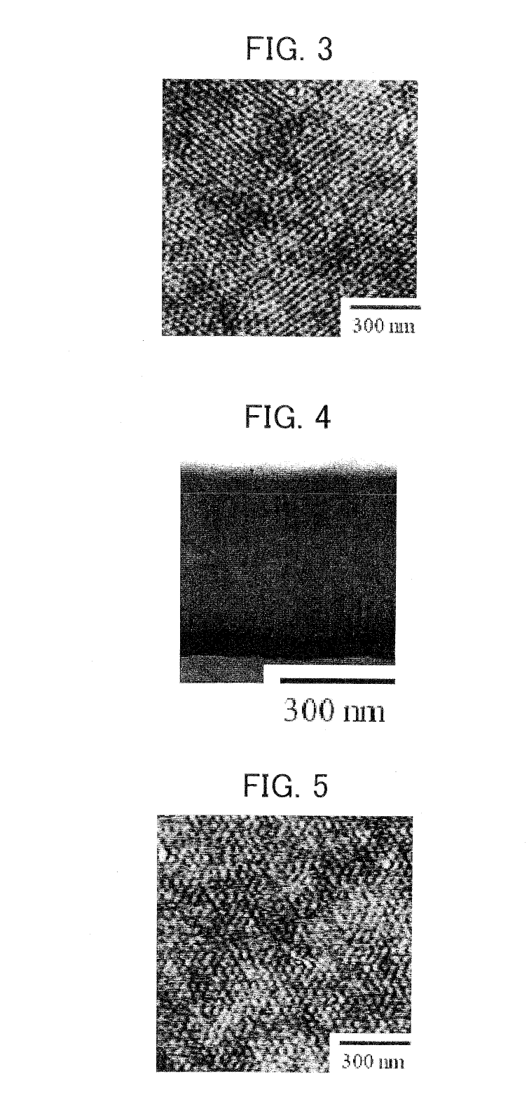

Next, a 3.50 wt % chloroform solution of PS-b-PMMA (Mw of PS=35,500; Mw of PMMA=12,200) was spin-coated (1,500 rpm, 30 seconds) onto the above substrate 1 and annealed at 220° C. under an atmosphere of N₂, thereby preparing a block copolymer layer with a thickness of about 450 nm. The resulting product was called Specimen A. FIG. 3 shows a surface AFM image of Specimen A. It was confirmed from the AFM image in FIG. 3 and from TEM examination carried out for the structure in its thickness direction (FIG. 4) that a perpendicular cylindrical phase-separated morphology in which cylindrical microdomains are perpendicularly oriented had formed in the block copolymer layer. With reference to the literature (Polymer 43, 2507 (2002)), Specimen A was cut with a microtome to observe its section.

### Example 2

Example 1 was repeated to prepare a polyimide film having a gold layer (50 nm) deposited thereon. The gold layer had a surface roughness Ra of 0.91 nm. Then, the film was immersed in a 1 mM ethanol solution of hexadecylamine and allowed to stand for 1 day. Subsequently, the resulting film was rinsed with ethanol and dried to prepare a flexible metal substrate 2 on which a metal adsorbing compound layer had been deposited. The thickness of the metal adsorbing compound layer as measured by the same method as in Example 1 was 2.3 nm. Following vapor deposition, the contact angle with water was 20.0°. Following surface modification, the contact angle with water was 101.2±8°. The difference between the surface tension of polystyrene (PS) with the substrate and the surface tension of polymethyl methacrylate (PMMA) with the substrate was 0.26 mN/m.

Next, a 3.50 wt % chloroform solution of PS-b-PMMA (Mw of PS=35,500; Mw of PMMA=12,200) was spin-coated (1,500 rpm, 30 seconds) onto the above substrate 2 and annealed at 220° C. under an atmosphere of N₂, thereby preparing a block copolymer layer with a thickness of about 400 nm. The resulting product was called Specimen B. FIG. 5 shows a surface AFM image of Specimen B. It was confirmed from the AFM image and from TEM examination carried out for the structure in its thickness direction that a perpendicular cylindrical phase-separated morphology in which cylindrical microdomains are perpendicularly oriented had formed in the block copolymer layer.

### Example 3

A copper layer (50 nm) was formed on a polyimide film by electron beam vapor deposition of copper. The copper layer had a surface roughness Ra of 1.08 nm. Following vapor deposition, the film was immediately immersed in a 1.0 wt % toluene solution of methoxyphenylethylamine and allowed to stand for one day. Subsequently, the resulting film was rinsed with toluene and dried to prepare a flexible metal substrate 3 on which a metal adsorbing compound layer had been deposited. The thickness of the metal adsorbing compound layer as measured by the same method as in Example 1 was 1.10 nm. Following vapor deposition, the contact angle was 21±4°. Following surface modification, the contact angle was 70±10°. The difference between the surface tension of polystyrene (PS) with the substrate and the surface tension of polymethyl methacrylate (PMMA) with the substrate was 0.10 mN/m.

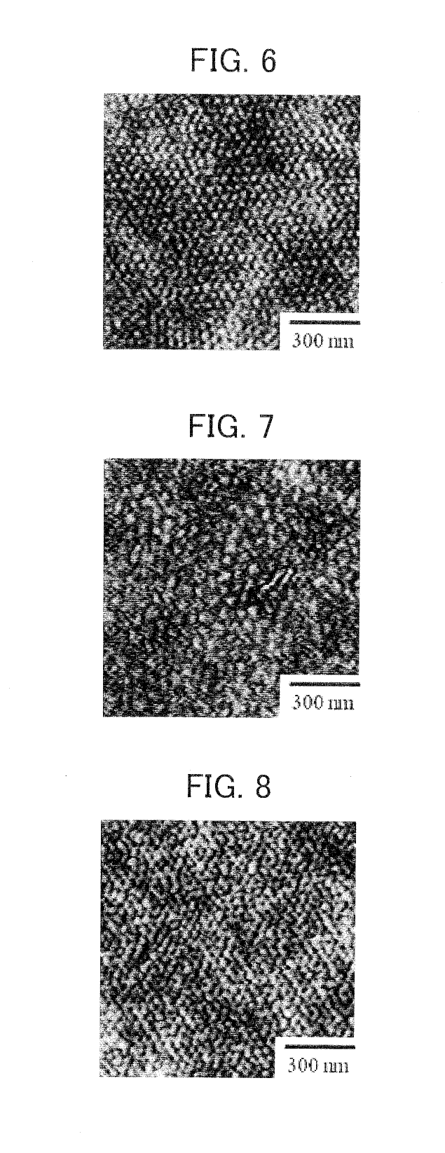

Next, a 3.50 wt % toluene solution of PS-b-PMMA (Mw of PS=35,500; Mw of PMMA=12,200) was spin-coated (1,500 rpm, 30 seconds) onto the above substrate 3 and annealed at 200° C. under an atmosphere of N₂, thereby preparing a block copolymer layer with a thickness of about 150 nm. The resulting product was called Specimen C. FIG. 6 shows a surface AFM image of Specimen C. It was confirmed from the AFM image and from TEM examination carried out for the structure in its thickness direction that a perpendicular cylindrical phase-separated morphology in which cylindrical microdomains are perpendicularly oriented had formed in the block copolymer layer.

### Example 4

An iron layer (50 nm) was formed on a polyimide film by electron beam vapor deposition of iron. The iron layer had a surface roughness Ra of 1.02 nm. Following vapor deposition, the film was immediately immersed in a 1.0 wt % toluene solution of methoxyphenylethylamine and allowed to stand for one day. Subsequently, the resulting film was rinsed with toluene and dried to prepare a flexible metal substrate 4 on which a metal adsorbing compound layer had been deposited. The thickness of the metal adsorbing compound layer as measured by the same method as in Example 1 was 1.10 nm. Following vapor deposition, the contact angle was 4.2°. Following surface modification, the contact angle was 72±8°. The difference between the surface tension of polystyrene (PS) with the substrate and the surface tension of polymethyl methacrylate (PMMA) with the substrate was 0.10 mN/m.

Next, a 2.50 wt % toluene solution of PS-b-PMMA (Mw of PS=68,000; Mw of PMMA=21,500) was spin-coated (1,500 rpm, 30 seconds) onto the above substrate 4 and annealed at 200° C. under an atmosphere of N₂, thereby preparing a block copolymer layer with a thickness of about 100 nm. The resulting product was called Specimen D. FIG. 7 shows a surface AFM image of Specimen D. It was confirmed from the AFM image and from TEM examination carried out for the structure in its thickness direction that a perpendicular cylindrical phase-separated morphology in which cylindrical microdomains are perpendicularly oriented had formed in the block copolymer layer.

### Example 5

Specimen A obtained in Example 1 was subjected to UV irradiation (25 J/cm²), then rinsed with acetic acid to remove the PMMA component. The resulting product was called Specimen E. FIG. 8 shows a surface AFM image of Specimen E. From FIG. 8, it was confirmed that the PMMA component had been removed and that cylindrical pores had formed in the block copolymer layer.

What is claimed is:

1. A structure comprising:
a flexible substrate and, in order thereon,
a metal layer,
a metal adsorbing compound layer, and
a block copolymer layer which has a microphase-separated morphology and is formed of a block copolymer obtained by bonding two or more mutually incompatible polymer chains,
wherein the microphase-separated morphology has one phase which is lamellar or cylindrical, and is oriented perpendicularly to the substrate.

2. The structure of claim 1, wherein the metal adsorbing compound layer has a thickness which is equal to or larger than a surface roughness Ra of the metal layer.

3. The structure of claim 1, wherein the metal adsorbing compound layer is a layer formed of a compound represented by general formula (1):
X-L-R General formula (1)
wherein R is a hydrogen atom, an optionally branched alkyl group or an alkoxy group, L is a divalent linkage group or merely a bond, X is a thiol group, an amino group, a selenol group, a nitrogen-containing heterocyclic group, an asymmetric or symmetric disulfide group, a sulfide group, a diselenide group or a selenide group.

4. The structure of claim 1, wherein the metal layer is a layer made of at least one metal selected from the group consisting of gold, platinum, silver, copper and iron.

5. A porous body obtained by removing polymer chains in one phase of the microphase-separated morphology from the structure of claim 1.

6. A method of manufacturing the structure of claim 1, comprising the steps of:
forming a metal layer on a flexible substrate;
forming a metal adsorbing compound layer on the metal layer; and
forming a block copolymer layer on the metal adsorbing compound layer.
